(19) United States
(12) Patent Application Publication
(10) Pub. No.: US 2008/0137856 A1
(43) Pub. Date: Jun. 12, 2008

(54) METHOD FOR GENERATING INDIRECT TRUST BINDING BETWEEN PEERS IN PEER-TO-PEER NETWORK

(75) Inventors: Gu Ja Beom, Seoul (KR); Nah Jae Hoon, Daejeon (KR); Jang Jong Soo, Daejeon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics & Telecommunications Research Institute, Daejeon (KR)

(21) Appl. No.: 11/947,500

(22) Filed: Nov. 29, 2007

(30) Foreign Application Priority Data
Dec. 6, 2006 (KR) 10-2006-0123367
May 9, 2007 (KR) 10-2007-0045195

(51) Int. Cl. H04K 1/00; H04L 9/00; G06F 21/00; H04L 9/28; G06F 19/00

(52) U.S. Cl. 380/255; 380/44; 726/1; 380/28

(57) ABSTRACT

Provided is a method for generating indirect trust binding between peers in a P2P network that allows communication and interaction between peers with trust even without an integrated processing server. In the method, a source peer transmits an initialization request message to a destination peer to receive a session identifier of the destination peer from the destination peer. The source peer arbitrarily selects a relay peer and then encrypts and generates indirect trust binding to the destination peer through the relay peer. The generation result of the indirect trust binding is analyzed, and trust of the destination peer is measured. The method allows the source peer to encrypt and generate the indirect trust binding to the destination peer even without a separate integrated processing server, and to be aware of trust of the destination peer.

### CROSS-REFERENCE TO RELATED APPLICATIONS

This application claims the priority of Korean Patent Application No. 10-2006-0123367 filed on Dec. 6, 2006, in the Korean Intellectual Property Office and Korean Patent Application No. 10-2007-0045195 filed on May 9, 2007 the disclosure of which is incorporated herein by reference.

### BACKGROUND OF THE INVENTION

1. Field of the Invention

The present invention relates to a peer-to-peer network (P2P), and more particularly, to an indirect trust binding method for allowing trust of a peer to be measured in a distributed P2P network having no server.

This work Was supported by the IT R&D program of MIC/IITA[2005-S-090-02, Development of P2P Network Security Technology based on Wired/Wireless IPv6 Network].

2. Description of the Related Art

In the P2P network, a great number of heterogeneous computing nodes (for example, peers or peers for short) are directly one-to-one (1:1) bound as in FIG. 1A, or multi-to-multi (N:N) bound as in FIG. 1B to share resources with the network in a distributed cooperating fashion.

FIG. 2 is a view illustrating the construction of a general P2P network.

Referring to FIG. 2, the P2P network includes a plurality of peers 21 through 25, and they communicate with one another via the Internet 30.

A geographical distance between the peers can be between a local-link and a global-link. The communication between the peers can be performed through multiple indirect connections. For example, in the case where a message directed from a first peer 21 to a second peer 22 cannot be directly delivered, a third peer 23 can relay the message.

The communication between the peers is associated with a resource sharing operation including a kind of resources shared between the peers and determination as to which peer is to share the resources, and a protocol. The resource sharing can be regarded as sharing data structures between the peers 21 through 25. Therefore, the P2P network can be realized in a variety of forms in association with an interaction between the peers.

Meanwhile, a general P2P network does not have an integrated processing server for management support and dynamic membership management for managing network entrance and withdrawal of a peer to and from the network.

Instead, the respective peers 21 through 25 should search for and be aware of other peers located inside the P2P network while periodically advertising themselves. Accordingly, the respective peers 21 through 25 have different views of the P2P network, respectively. The views also change depending on time.

Subsequently, referring to FIG. 2, the respective peers 21 through 25 have at least one identifier (ID) to represent themselves on the P2P network. A generating frequency of the ID is not limited, and one peer 25, for example, can generate a plurality of Ids.

However, when one peer 25 generates and has a plurality of Ids, the peer 25 may intentionally deliver a communication message and routing information of other peer on the network in an erroneous manner (wrong delivery), or may spoil or miss the communication message and routing information. In this case, the peer 25 is regarded as a potentially dangerous peer. That is, when an adverse attacker intends to attack the P2P network with an adverse intent, he may generate a plurality of IDs and make an attack such as wrong delivery, spoil, and missing to cause a great damage.

However, as described above, the P2P network has no integrated processing server capable of managing and processing the peers. So, the P2P network is exposed to these attacks defenselessly.

Accordingly, peers inside the conventional P2P network have not been able to completely trust one another.

### SUMMARY OF THE INVENTION

An aspect of the present invention provides a method for generating indirect trust binding between peers in a P2P network, capable of allowing the peers to communicate and interact with one another while trusting one another even without an integrated processing server.

According to an aspect of the present invention, there is provided a method for generating indirect trust binding in a peer-to-peer (P2P) network, the method including: transmitting, at a source peer, an initialization request message to a destination peer to receive a session identifier of the destination peer from the destination peer; arbitrarily selecting, at the source peer, a relay peer, and then encrypting and generating indirect trust binding to the destination peer through the relay peer; and analyzing a generation result of the indirect trust binding, and measuring trust of the destination peer.

### BRIEF DESCRIPTION OF THE DRAWINGS

The above and other aspects, features and other advantages of the present invention will be more clearly understood from the following detailed description taken in conjunction with the accompanying drawings, in which:

FIG. 1A is a conceptual view of a general one-to-one trust generation;

FIG. 1B is a conceptual view of a general multi-to-multi trust generation;

FIG. 2 is a construction view of a general P2P network;

FIG. 3A is a conceptual view of trust generation according to an embodiment of the present invention;

FIG. 3B is a conceptual view of trust generation according to another embodiment of the present invention;

FIG. 4 is a flowchart explaining a method for generating indirect trust binding between peers on a P2P network according to an embodiment of the present invention;

FIG. 5 is a flowchart explaining in more detail the initialization process of FIG. 4;

FIG. 6 is a flowchart explaining in more detail the indirect trust binding request process of FIG. 4;

FIG. 7 is a flowchart explaining in more detail the indirect trust binding request relay process of FIG. 4;

FIG. 8 is a flowchart explaining in more detail the indirect trust binding request checking process of FIG. 4; and

FIG. 9 is a flowchart explaining in more detail the trust measuring process of FIG. 4.

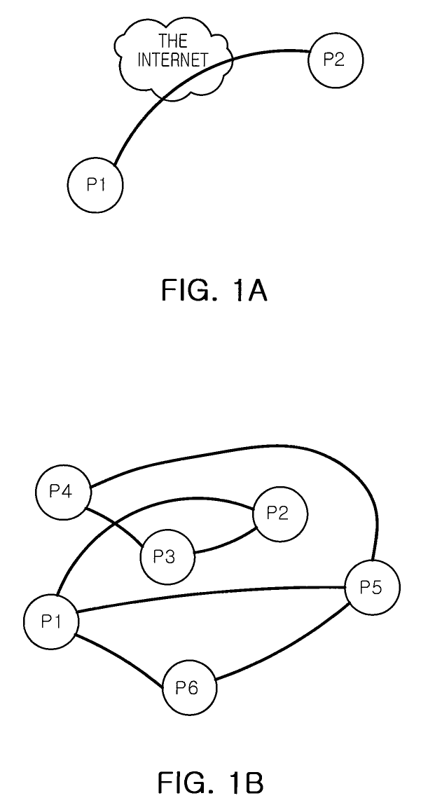

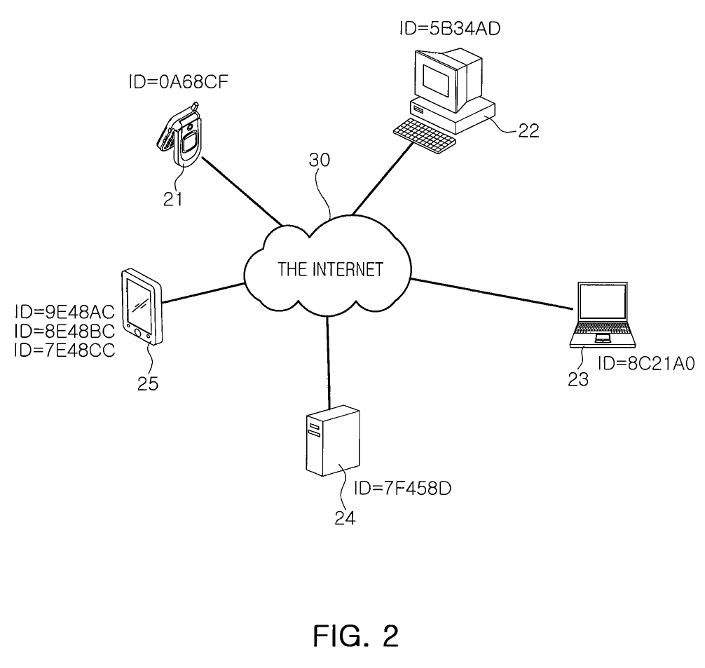

### DETAILED DESCRIPTION OF THE PREFERRED EMBODIMENT

Exemplary embodiments of the present invention that would be easily embodied by those of ordinary skill in the art will now be described in detail with reference to the accompanying drawings. However, in detailed description of operational principle according to the exemplary embodiments, well-known functions, well-known structures will not be described in detail to avoid ambiguous interpretation of the present invention.

Also, like reference numerals are used for like elements throughout the specification.

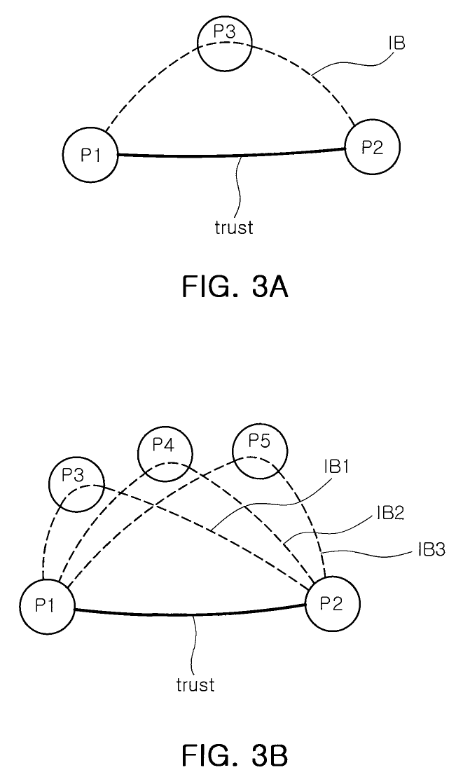

FIGS. 3A and 3B are views explaining concept of a method for generating indirect trust binding according to an embodiment of the present invention. FIG. 3A illustrates the case of using one relay peer, and FIG. 3B illustrates the case of using a plurality of relay peers.

Referring to FIG. 3A, a peer P1 selects an arbitrary peer P3 and encrypts a message for generating indirect trust binding, and then transmits the encrypted message to a counterpart peer P2 through the arbitrary peer P3.

Accordingly, since an attacker cannot analyze a message for generating indirect trust binding, indirect trust binding 1B between the peers P1 and P2 is always safely formed.

The indirect trust binding generating results are analyzed, so that the peer P1 can measure trust for the counter part peer P2.

The attack is very difficult or impossible when the indirect trust binding is formed even when an adverse attacker generates the plurality of IDs and makes an attack such as wrong delivery, spoil, and miss to attack a P2P network.

Therefore, the peer P1 checks that the attack has not been made during communication with the counterpart peer P2 in view of the fact that indirect binding to the counterpart peer P2 has been formed.

Also, referring to FIG. 3B, the peer P1 arbitrarily selects a plurality of peers P3 through P5, generates a plurality of indirect trust bindings IB1 through IB3 to the counterpart peer P2 using the respective peers P3 through P5, and analyzes the results of the plurality of indirect trust binding generations to measure trust regarding the counterpart peer P2.

Using the arbitrarily selected plurality of peers P3 through P5 to generate the indirect trust binding allows an adverse attacker not to an indirect trust binding path in advance.

Also, since the method of FIG. 3B can have more judgment bases than those of the method of FIG. 3A, the trust of the counterpart peer P2 can be measure more accurately.

According to the present invention, a message for generating indirect trust binding is encrypted according to identity-based cryptography (IBC) mechanism, and is used as a public key for encrypting a session identifier of each peer according to the IBC mechanism.

Since the IBC mechanism is known technology in “Shamir (1984) Identity-Based Cryptosystems and Signature Schemes, Proceedings of Crypto '84, Lecture Notes in Computer Science no. 196, Springer Veriag 1985)”, detailed description thereof is omitted.

Hereinafter, the peer P1 requesting indirect trust binding is referred to as a source peer, the peer P2 relaying the indirect trust binding is referred to as a relay peer, and the counterpart peer P3 forming indirect trust binding to the source peer is referred to as a destination peer, for convenience in description.

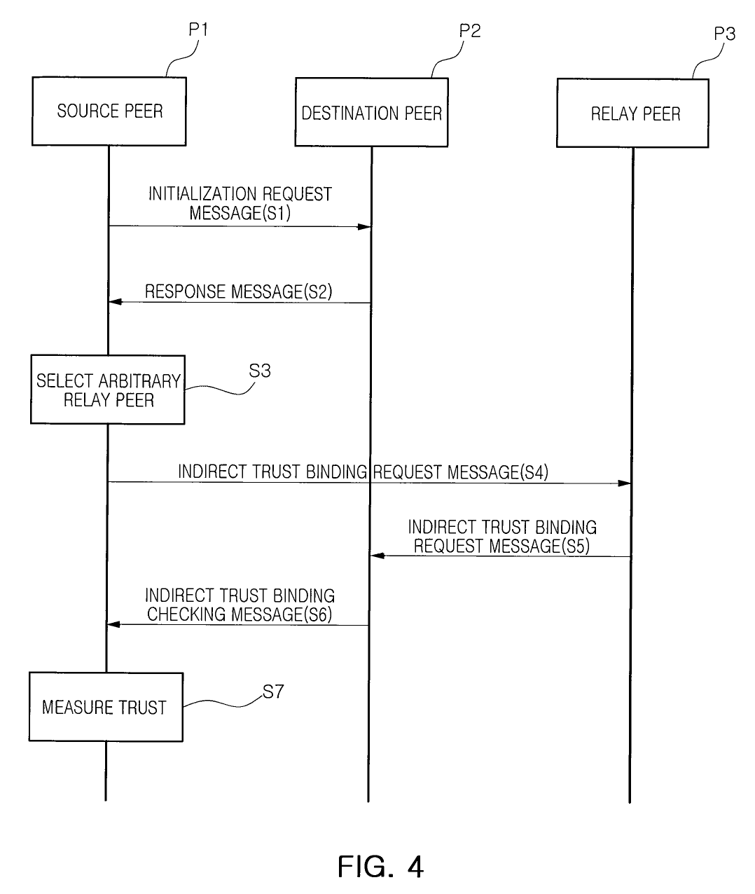

FIG. 4 is a flowchart explaining a method for generating indirect trust binding between peers on a P2P network according to an embodiment of the present invention.

In operation S1, the source peer P1 generates an initialization request message of the destination peer P2 for receiving a session identifier of the destination peer P2 to transmit the same to the destination peer P2.

In operation S2, the destination peer P2 receives and analyzes the initialization request message to generate a response message including a session identifier of itself, and transmits the same to the source peer P1.

In operation S3, the source peer P1 selects one of a plurality of peers on the P2P network as a relay peer P3. In operation S4, the source peer P1 generates an indirect trust binding request message encrypted using the session identifier of itself, a session identifier of the destination peer, and a session identifier of the relay peer according to the IBC mechanism to transmit the same to the relay peer P3 selected in operation S3.

In operation S5, the relay peer P3 receives and analyzes the indirect trust binding request message to detect the destination peer P2, and delivers the received indirect trust binding request message to the detected destination peer P2. That is, the relay peer P3 relays the indirect trust binding request message generated by the source peer P1 to the destination peer P2.

In operation S6, the destination peer P2 forms indirect trust binding to the source peer P1 in response to the indirect trust binding request message, and generates an indirect trust binding checking message encrypted using the session identifier of itself, and a session identifier of the source peer to transmit the same to the source peer P1.

In operation S7, the source peer P1 receives and analyzes the indirect trust binding checking message to check an indirect trust binding generation result, and measures trust of the destination peer P2.

Also, the source peer P1 can arbitrarily select a new relay peer to repeatedly perform operations S4 through S7 to more accurately measure trust as illustrated in FIG. 3B.

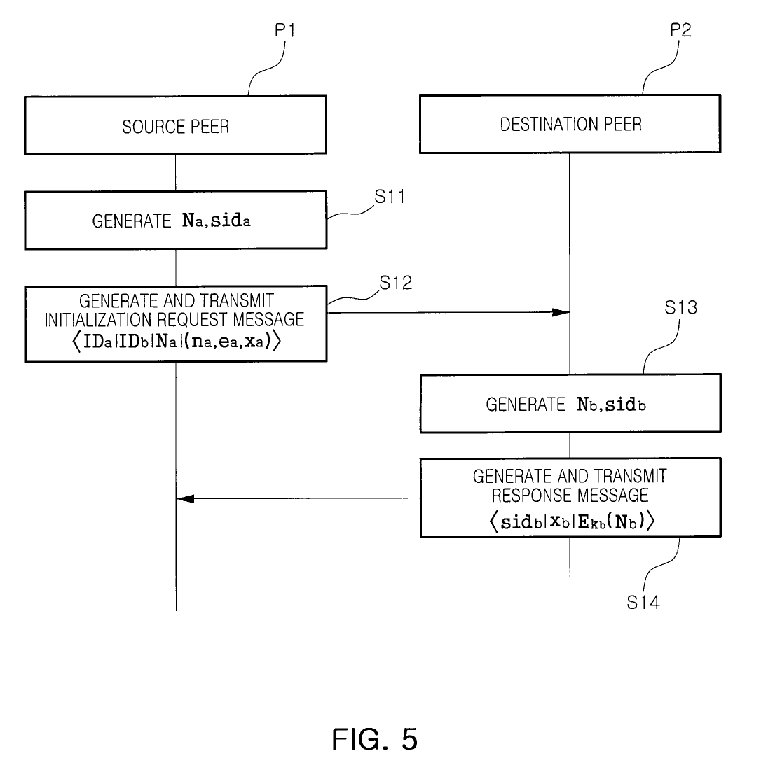

FIG. 5 is a flowchart explaining in more detail the initialization process S1 and S2 of FIG. 4.

In operation S11, the source peer P1 generates a nonce Nₐ (referred to as a session identifier nonce of the source peer) used only once for generating a unique session identifier sidₐ, and generates the session identifier sidₐ using the nonce Nₐ.

At this point, the session identifier sidₐ is generated using Equation 1 below.

sidₐ=h(IDₐ|O|O|Nₐ|IPₐ) Equation 1

where h denotes a cryptographic hash function, IDₐ denotes an ID of the source peer, “0” denotes first and second parameters set to “0”, IPₐ denotes an IP address of the source peer, and ‘|’ denotes a connection state between two strings.

Also, in operation S12, the source peer P1 generates an initialization request message including its IDₐ, ID_{b} of the destination peer, a session identifier nonce Nₐ, IBC parameters nₐ and eₐ, and an intermediate value xₐ for key match of the source peer P1 to transmit the same to the destination peer P2.

Here, the initialization message is generated using Equation 2 below.

[symbol]

IDₐ|ID_{b}|Nₐ|(nₐ,eₐ,xₐ) [symbol] Equation 2

In operation S13, the destination peer P2 that has received the initialization request message generates a nonce N_{b} (referred to as a session identifier nonce of the destination peer) used only once for generating a unique session identifier sid_{b} in response to the received the initialization request message, and generates the session identifier sid_{b} from the nonce N_{b}. Also, the destination peer P2 extracts an intermediate value Xₐ for key match of the source peer, a session identifier sidₐ, and an IP address IPₐ contained in the initialization request message, and calculates a session key K_{b} of the destination peer using them.

Here, the session identifier sid_{b} of the destination peer is generated using Equation 3 below, and the session key K_{b} is calculated by Equation 4 below.

sid_{b}=h(ID_{b}|Nₐ|N_{b}|IP_{b}) Equation 3

K_{b}=(xₐ·sidₐ|IPₐ)^{r}^{_{b}} mod n_{b} Equation 4

where r_{b} denotes a nonce (referred to as a session key nonce of the destination peer) used only once for the destination peer to generate a unique session key, and n_{b} denotes a composite number obtained by multiplying two large prime numbers and by the destination peer.

In operation S14, the destination peer P2 generates a response message including its session identifier sid_{b}, an intermediate value x_{b} for key match, and its session identifier nonce (E_{kb}(N_{b})) encrypted by the session key K_{b} to transmit the same to the source peer P1.

Here, the response message is generated using Equation 5 below.

[symbol]

sid_{b}|x_{b}|E_{K}_{_{b}}(N_{b}) [symbol] Equation 5

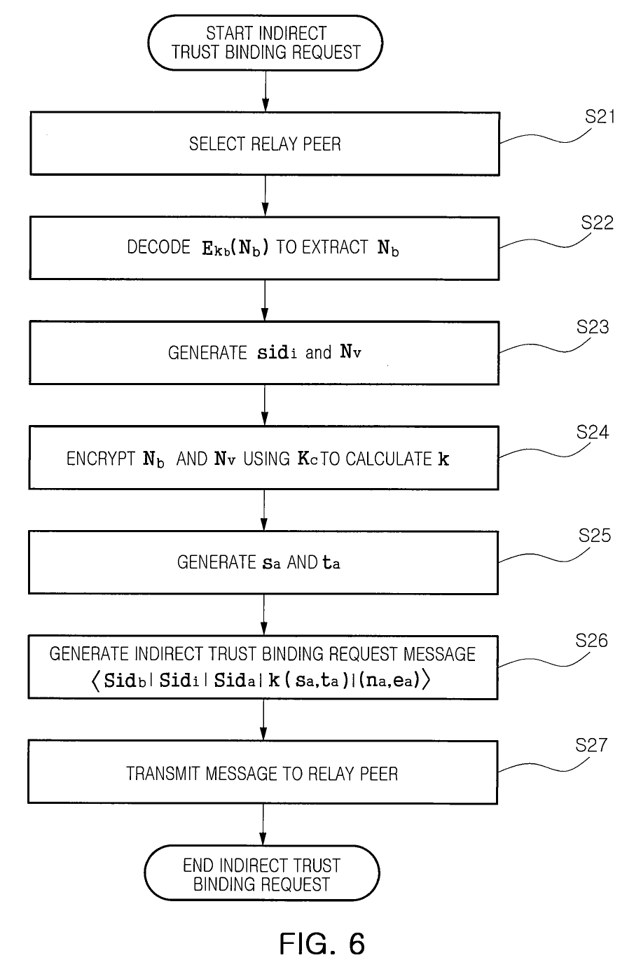

FIG. 6 is a flowchart explaining in detail the indirect trust binding request operation S4 performed at the source peer after the initialization operation of FIG. 5 is performed.

In operation S21, the source peer P1 selects one of peers found on the P2P network as the relay peer P3 to form indirect trust binding to the destination peer P2.

In operation S21, the source peer P1 can arbitrarily select and use one of peers appearing on its view as the relay peer.

In operation S22, after calculating the session key Kₐ of itself, the source peer P1 decodes a session identifier nonce E_{kb}(N_{b}) of the destination peer encrypted and contained inside the response message using the calculated session key Kₐ to extract a session identifier nonce N_{b} of the destination peer.

Here, the session key of the source peer is generated using Equation 6 below.

Kₐ=(x_{b}·sid_{b}|IP_{b})^{r}^{ₐ} mod n_{b} Equation 6

where rₐ denotes a nonce (referred to as a session key nonce of the source peer) used only once for a unique session key Kₐ, and n_{b} denotes a composite number obtained by multiplying two large prime numbers and by the destination peer.

The source peer P1 generates a nonce Nᵥ for indirect trust binding in operation S23, and encrypts the session identifier nonce N_{b} of itself and the nonce Nᵥ (referred to as a binding nonce) for indirect trust binding using the session identifier session key Kₐ to extract a key material k in operation S24.

Here, the key material k is generated using Equation 7 below.

k=E_{K}_{ₐ}(Nᵥ|N_{b}) Equation 7

After generating its signatures sₐ and tₐ in operation S25, the source peer P1 generates an indirect trust binding request message including its session identifier sidₐ, the session identifier sidᵢ of the relay peer, the session identifier sid_{b} of the destination peer, the key material k, signatures sₐ and tₐ, and IBC parameters nₐ and eₐ in operation S26.

Here, the signatures sₐ and tₐ of the source peer are generated using Equation 8 below, and the indirect trust binding request message is generated using Equation 9 below.

tₐ=rₐ^{e}^{ₐ} mod nₐ

sₐ=gₐ·rₐ^{h(t}^{ₐ}^{|sid}^{_{b}}^{|sid} ^{ₐ}^{|k)}mod nₐ Equation 8

[symbol]

sidₐ|sid_{b}|sidᵢ|k|(sᵢ,tᵢ)|(nᵢ,eᵢ) [symbol] Equation 9

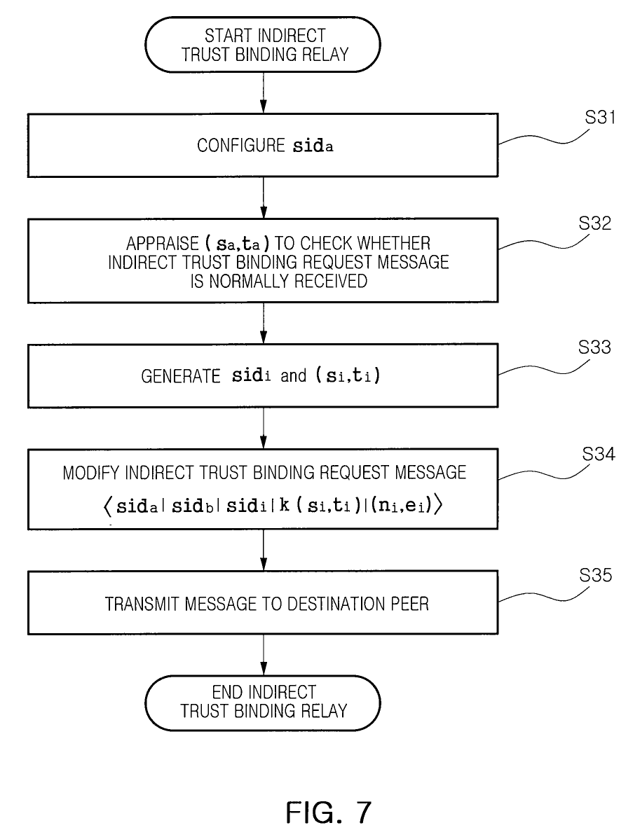

FIG. 7 is a flowchart explaining in detail the indirect trust binding request relay operation S5 performed at the relay peer in the case where an indirect trust binding request message is received as in FIG. 6.

When receiving an indirect trust binding request message transmitted from the source peer P1, the relay peer P3 forms the session identifier sidₐ of the source peer in operation S31, and analyzes the signatures sₐ and tₐ inside the indirect trust binding request message to check whether the indirect trust binding request message is normal in operation S32.

After generating its session identifier sidᵢ and the signatures sₐ and tₐ in operation S33, the relay peer P3 modifies the received indirect trust binding request message to an indirect trust binding request message including the session identifier sidₐ of the source peer, the session identifier sid_{b} of the destination peer, its session identifier sidᵢ, the key material k, signatures sᵢ and tᵢ of itself, and IBC parameters nᵢ and eᵢ in operation S34.

Here, the modified indirect trust binding request message is generated using Equation 10 below.

[symbol]

sid_{b}|sid_{b}|sidᵢ|k|(sᵢ,tᵢ)|(nᵢ,eᵢ) [symbol] Equation 10

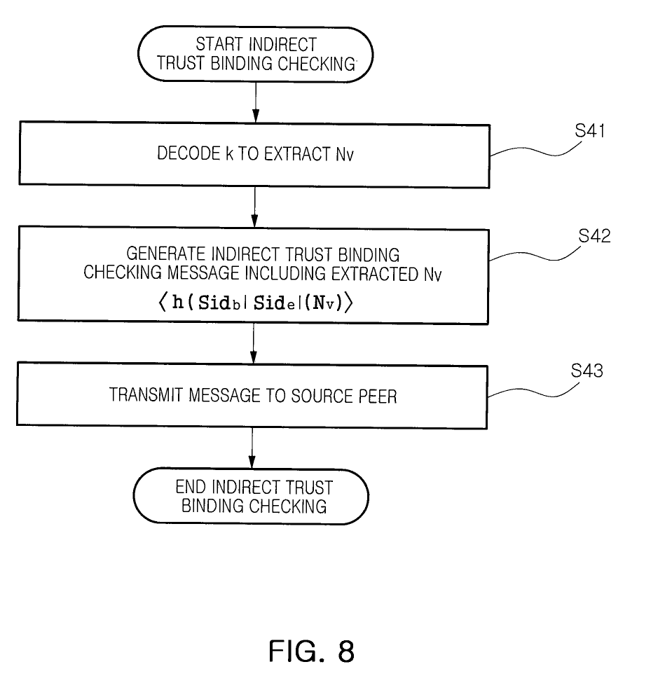

FIG. 8 is a flowchart explaining in detail the indirect trust binding request message checking operation S5 performed at the destination peer in the case where an indirect trust binding request message is received from the relay peer P3 in FIG. 7.

In operation S41, the destination peer P2 receives the indirect trust binding request message transmitted from the relay peer P3, and decodes the key material K in the message to extract a binding nonce Nᵥ.

Also, in operation S42, the destination peer P2 generates an indirect trust binding checking message including its session identifier sid_{b}, the session identifier sidₐ of the source peer, and the binding nonce Nᵥ extracted in operation S41, and transmits the indirect trust binding checking message to the source peer in operation S43.

Here, the indirect trust binding checking message is generated using Equation 11 below.

[symbol]

h(sid_{b}|sidₐ|Nᵥ) [symbol] Equation 11

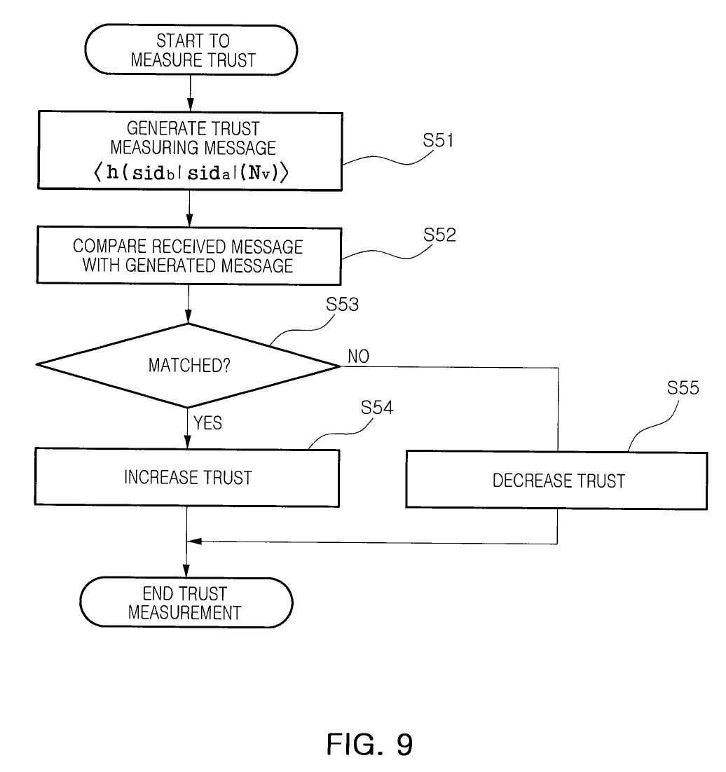

FIG. 9 is a flowchart explaining in detail the trust measuring operation S6 performed at the source peer in the case where an indirect trust binding request checking message is received in FIG. 8.

After transmitting an indirect trust binding request message to the relay peer P3, the source peer P1 separately generates a trust measuring message including the session identifier sid_{b} of the destination peer, its session identifier sidₐ, and the binding nonce Nᵥ in operation S51.

In operation S52, when an indirect trust binding checking message is received from the destination peer P2, the source peer P1 checks whether the received message coincides with the message generated in operation S51.

When the received message coincides with the message generated in operation S51, the source peer P1 checks that the indirect trust binding operation has been successfully performed and increases trust of the destination peer P2 in operation S53. When the received message does not coincide with the message generated in operation S51, the source peer P1 checks that the indirect trust binding has been abnormally performed and decreases trust of the destination peer P2 in operation S54.

As described above, in the method for generating indirect trust binding between peers on the P2P network according to the present invention, a source peer generates indirect trust binding to a destination peer even without a separate integrated processing server. Since the indirect trust binding is not broken down by an attacker, the source peer can be aware of trust of the destination peer using a trust binding generation result.

Also, since the indirect trust binding of the present invention is instantly generated if necessary, the indirect trust binding is not influenced at all by frequent modifications (frequent entrances and withdrawals of peers) of topology of the P2P network.

While the present invention has been shown and described in connection with the exemplary embodiments, it will be apparent to those skilled in the art that modifications and variations can be made without departing from the spirit and scope of the invention as defined by the appended claims.

What is claimed is:

1. A method for generating indirect trust binding in a peer-to-peer (P2P) network, the method comprising:
transmitting, at a source peer, an initialization request message to a destination peer to receive a session identifier of the destination peer from the destination peer;
arbitrarily selecting, at the source peer, a relay peer, and then encrypting and generating indirect trust binding to the destination peer through the relay peer; and
analyzing a generation result of the indirect trust binding, and measuring trust of the destination peer.

2. The method of claim 1, wherein a message for generating the indirect trust binding is encrypted according to an identifier-based cryptography (IBC) mechanism.

3. The method of claim 1, wherein the arbitrarily selecting of the relay peer, and the encrypting and generating of the indirect trust binding could be repeatedly performed while selecting a new relay peer.

4. The method of claim 1, wherein the transmitting, of the initialization request message comprises:
generating, at the source peer, a session identifier nonce and a session identifier of the source peer;
generating, at the source peer, a session identifier of the source peer, the session identifier of the destination peer, and the initialization request message comprising a session identifier nonce of the source peer, IBC parameters, and an intermediate value for key match to transmit the same to the destination peer;
generating, at the destination peer that has received the initialization request message, a session identifier nonce, a session identifier, and a session key of the destination peer; and
generating, at the destination peer, a response message comprising the session identifier, an intermediate value for key match, and an encrypted session identifier nonce of the destination peer, and transmitting the same to the source peer.

5. The method of claim 4, wherein the session identifier is given by sidₐ=h(IDₐ|O|O|Nₐ|IPₐ),
where h denotes a cryptographic hash function, IDₐ denotes an identifier of the source peer, Nₐ denotes a session identifier nonce of the source peer, IPₐ denotes an IP address of the source peer, and ‘|’ denotes a connection state between strings.

6. The method of claim 4, wherein the session identifier of the destination peer is given by sid_{b}=h(ID_{b}|Nₐ|N_{b}|IP_{b}),
where h denotes a cryptographic hash function, ID_{b} denotes an identifier of the destination peer, Nₐ denotes a session identifier nonce of the source peer, N_{b} denotes a session identifier nonce of the destination peer, IP_{b} denotes an IP address of the destination peer, and ‘|’ denotes a connection state between strings.

7. The method of claim 4, wherein the session key of the destination peer is given by K_{b}=(xₐ·sidₐ|IPₐ)^{r}^{_{b}} mod n_{b},
where xₐ denotes an intermediate value for key match of the source peer, sidₐ denotes a session identifier of the source peer, IPₐ denotes an IP address of the source peer, r_{b} denotes a session key nonce of the destination peer, and n_{b} denotes a composite number of the destination peer obtained by multiplying two large prime numbers.

8. The method of claim 4, wherein the initialization request message is given by [symbol] IDₐ|ID_{b}|Nₐ|(nₐ,eₐ,xₐ) [symbol] ,
where IDₐ denotes an identifier of the source peer, ID_{b} denotes an identifier of the destination peer, Nₐ denotes a session identifier nonce of the source peer, nₐ and eₐ denote IBC parameters of the source peer, and xₐ denotes an intermediate value for key match of the source peer.

9. The method of claim 4, wherein the response message is given by [symbol] sid_{b}|x_{b}|E_{K}_{_{b}}(N_{b}) [symbol] ,
where sid_{b} denotes a session identifier of the destination peer, x_{b} denotes an intermediate value for key match of the destination peer, N_{b} denotes a session identifier nonce of the destination peer, and E_{kb}(N_{b}) denotes a session identifier nonce of the destination peer encrypted using the session key K_{b} of the destination peer.

10. The method of claim 4, wherein the arbitrarily selecting of the relay peer comprises:
selecting, at the source peer, one of a plurality of peers on the P2P network as the relay peer;
generating, at the source peer, an indirect trust binding request message, and transmitting the same to the relay peer;
modifying, at the relay peer, the indirect trust binding request message, and transmitting the same to the destination peer; and
checking, at the destination peer, whether indirect trust binding is normally performed in response to the modified indirect trust binding request message, and then transmitting an indirect trust binding checking message to the source peer.

11. The method of claim 10, wherein the generating of the indirect trust binding request message comprises:
configuring, at the source peer, a session key of the source peer, decoding the encrypted session identifier nonce of the destination peer to extract the session identifier nonce of the destination peer;
generating, at the source peer, the session key of the source peer, a session identifier, and a binding nonce of the relay peer;
encrypting, at the source peer, the session identifier nonce of the destination peer and a nonce for indirect trust binding nonce using the session key of the source peer to generate a key material;
generating signatures at the source peer; and
generating, at the source peer, the session identifier of the destination peer, the session identifier of the relay peer, and the indirect trust binding request message comprising the session identifier of the source peer, the key material, the signatures, and the IBC parameters, and then transmitting the same to the relay peer.

12. The method of claim 11, wherein the session key of the source peer is given by Kₐ=(x_{b}·sid_{b}|IP_{b})^{r}^{ₐ} mod n_{b},
where x_{b} denotes an intermediate value for key match of the destination peer, sid_{b} denotes a session identifier of the destination peer, IP_{b} denotes an IP address of the destination peer, rₐ denotes a session key nonce of the source peer, and n_{b} denotes a composite number obtained by multiplying two large prime numbers and by the destination peer.

13. The method of claim 11, wherein the key material is given by k=E_{K}_{ₐ}(Nᵥ|N_{b}),
where Nᵥ denotes a binding nonce, and N_{b} denotes a session identifier nonce of the destination peer.

14. The method of claim 11, wherein the signatures are given by (sₐ,tₐ),
where sₐ=gₐ·rₐ^{h(t}^{ₐ}^{|sid}^{_{b}}^{|sid}^{ₐ}^{|k)}mod nₐ, and tₐ=rₐ^{e}^{ₐ} mod nₐ.

15. The method of claim 11, wherein the indirect trust binding request message is given by [symbol] sidₐ|sid_{b}|sidᵢ|k|(sᵢ,tᵢ)|(nᵢ,eᵢ) [symbol] ,
where sid_{b} denotes a session identifier of the destination peer, sidᵢ denotes a session identifier of the relay peer, sidₐ denotes a session identifier of the source peer, k denotes a key material, (sₐ, tₐ) denote signatures of the source peer, and (nₐ,eₐ) denote IBC parameters of the source peer.

16. The method of claim 10, wherein the modifying of the indirect trust binding request message comprises:
configuring, at the relay peer, the session identifier of the source peer, and checking whether the indirect trust binding request message is normally received using the signatures;
generating, at the relay peer, a session identifier and signatures of the relay peer; and
generating, at the relay peer, the session identifier of the source peer, the session identifier of the destination peer, and the indirect trust binding request message comprising the session identifier of the relay peer, the key material, the signatures, and the IBC parameters, and then transmitting the same to the destination peer.

17. The method of claim 16, wherein the indirect trust binding request message is given by [symbol] sidₐ|sid_{b}|sidᵢ|k|(sᵢ,tᵢ)|(nᵢ,eᵢ) [symbol] ,
where sidₐ denotes a session identifier of the source peer, sid_{b} denotes a session identifier of the destination peer, sidᵢ denotes a session identifier of the relay peer, k denotes a key material, (sᵢ, tᵢ) denote signatures of the relay peer, and (nᵢ,eᵢ) denote IBC parameters of the relay peer.

18. The method of claim 10, wherein the checking of whether the indirect trust binding is normally performed comprises:
decoding, at the destination peer, the key material contained in the modified indirect trust binding request message using the session key of the destination peer to extract a binding nonce; and
transmitting the indirect trust binding checking message comprising the session identifier of the destination peer, the session identifier of the source peer, and the extracted binding nonce to the source peer.

19. The method of claim 18, wherein the indirect trust binding checking message is given by [symbol] h(sid_{b}|sidₐ|Nᵥ) [symbol] ,
where h denotes a cryptographic hash function, sid_{b} denotes the session identifier of the destination peer, sidₐ denotes the session identifier of the source peer, and Nₐ denotes the binding nonce.

20. The method of claim 10, wherein the measuring of the trust comprises:
generating, at the source peer, a trust checking message comprising the session identifier of the destination peer, the session identifier of the source peer, and a binding nonce;
comparing the generated message with the indirect trust binding checking message transmitted from the destination peer to check whether the indirect trust binding is normally performed; and
measuring trust of a communication link between the source peer and the destination peer using the checking result.
